(19) United States
(12) Patent Application Publication
(10) Pub. No.: US 2024/0400469 A1
(43) Pub. Date: Dec. 5, 2024

(54) Soil Amendment For Use In Organic System

(71) Applicant: Tuscarora Grain Co., LLC, Mohrsville, PA (US)

(72) Inventor: Chris Johnson, Delmar, DE (US)

(73) Assignee: Tuscarora Grain Co., LLC, Mohrsville, PA (US)

(21) Appl. No.: 18/327,983

(22) Filed: Jun. 2, 2023

(51) Int. Cl. C05F 5/00; C05F 1/00; C05G 5/14; C05G 5/40

(52) U.S. Cl. CPC C05F 5/002; C05F 1/002; C05F 1/005; C05G 5/14; C05G 5/40

(57) ABSTRACT

A soil amendment for use in an organic system includes a protein ingredient and a binder binding with the protein ingredient to form a pellet. The protein ingredient is at least one of a plant-based protein and an animal-based protein. The binder is a grain processing by-product.

### FIELD OF THE INVENTION

The present invention relates to a soil amendment used for growing plants and, more particularly, to a soil amendment usable in an organic system.

### BACKGROUND

Soil amendments are used in agricultural, home garden, or other applications to help crops and other plants grow to produce a harvestable yield, flowers, or other desirable plant outputs. The soil amendments are applied in many different forms, in different compositions, and at different times to achieve these goals.

Many available soil amendments are not usable in organic systems. For producers of goods derived from plants, non-organic soil amendments limit the ability of the product to obtain organic approval and thereby limit the marketability of the produced plant goods. Some users of soil amendments for home application likewise prefer soil amendments that are usable in organic systems, especially for consumable plants. The most common soil amendment usable in organic systems, however, is manure, which has inherent difficulties at least in storage, transportation, and application. There is a need for a soil amendment usable in an organic system that is easier to package, transport, and use in commercial and residential applications.

### SUMMARY

A soil amendment usable in an organic system includes a protein ingredient and a binder binding with the protein ingredient to form a pellet. The protein ingredient is at least one of a plant-based protein and an animal-based protein. The binder is a grain processing by-product.

### BRIEF DESCRIPTION OF THE DRAWINGS

The invention will now be described by way of example with reference to the accompanying Figures, of which:

FIG. 1 is a schematic diagram of a plurality of pellets of a soil amendment for use in an organic system according to an embodiment of the invention;

FIG. 2A is a chart of a plurality of example compositions of the soil amendment for use in an organic system;

FIG. 2B is a chart of another plurality of example compositions of the soil amendment for use in an organic system;

FIG. 3 is a schematic diagram of a processing system according to embodiment used to produce the soil amendment for use in an organic system in pellet form;

FIG. 4 is a schematic diagram of a feeder bin and a pellet mill of the processing system; and

FIG. 5 is a flowchart of a process of using the processing system to produce the soil amendment for use in an organic system in pellet form.

### DETAILED DESCRIPTION OF THE EMBODIMENT(S)

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art. In addition, in the following detailed description, for purposes of explanation, numerous specific details are set forth to provide a thorough understanding of the disclosed embodiments. However, it is apparent that one or more embodiments may also be implemented without these specific details.

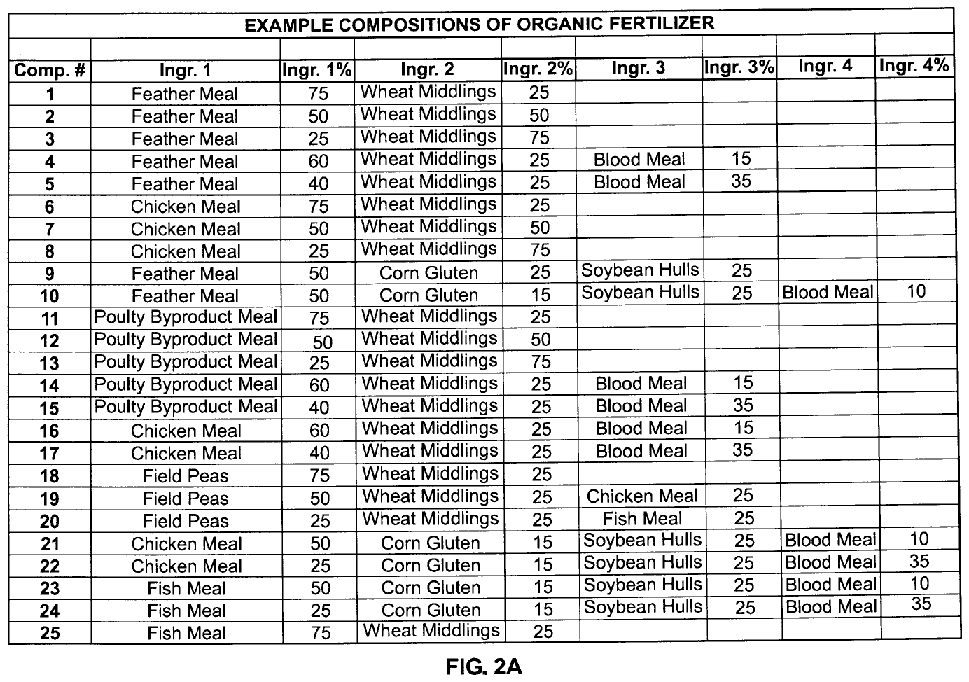

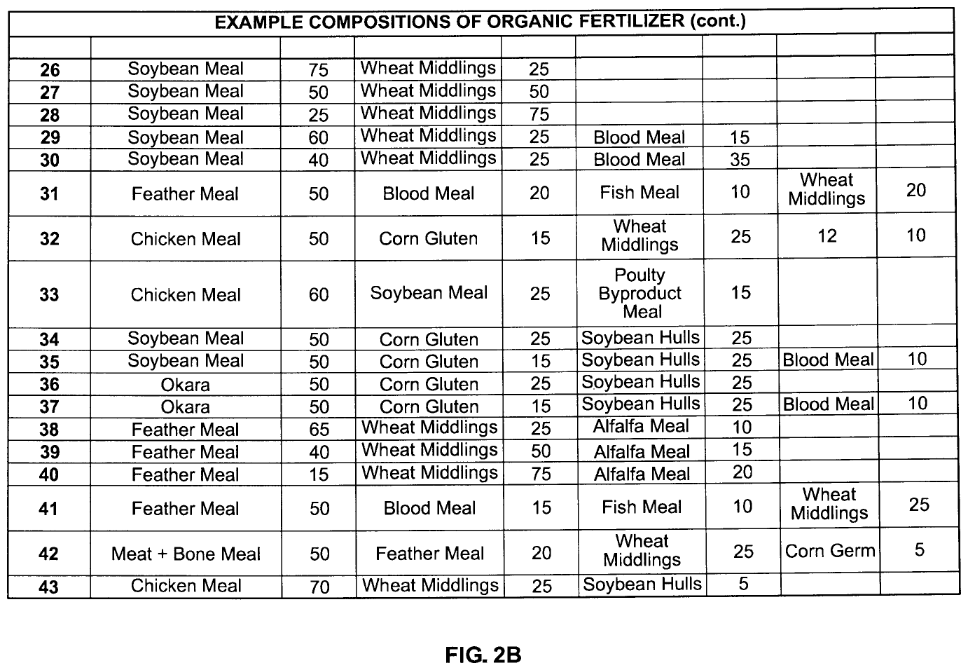

The ingredient percentages written in the detailed description, listed in the tables of the specification, and shown in FIGS. 2A and 2B of the drawings are intended to be interpreted as +/−5% of the value shown; +/−5% or the listed percentage or +/−5% of each end of the disclosed range.

The phrase “soil amendment for use in an organic system” as used throughout the specification is intended to mean that the material components comprising the soil amendment as described below are capable of being approved for use in an organic system by a governing body of organic materials. The phrase “soil amendment for use in an organic system” encompasses any type of fertilizer or soil amendment, as the terms are commonly understood in the art, that is approved for use in an otherwise organic growing system, but the term “soil amendment for use in an organic system” does not necessarily imply that the material components of the soil amendment or the soil amendment itself have met or are capable of meeting any formal organic certification standards.

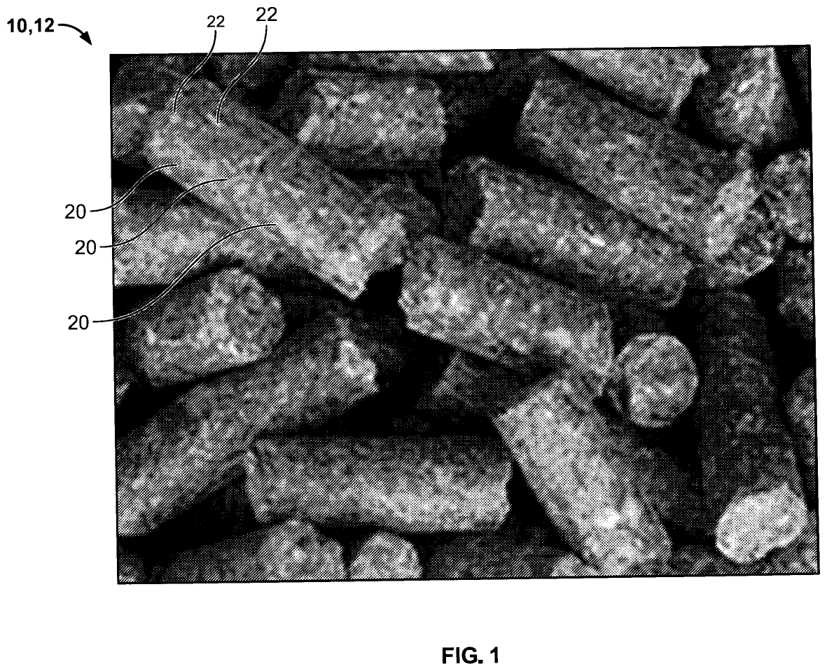

A soil amendment for use in an organic system 10 according to the invention in the form of a plurality of pellets 12 is shown in FIG. 1. Throughout the specification, the soil amendment for use in an organic system 10 may be referred to only as a “soil amendment 10” in the interest of brevity, but the “soil amendment 10” is understood as usable in an organic system according to the definition provided above in all embodiments. As also described above, the term “soil amendment 10” encompasses both soil amendments and fertilizers as the terms are commonly understood in the art.

The possible compositions of the soil amendment 10 will first be described in detail below, followed by a description of a processing system 100 and corresponding process 200 used to produce the pellets 12 of the soil amendment 10.

The soil amendment for use in an organic system 10 includes a protein ingredient 20 and a binder 22 that binds with the protein ingredient 20 to form the pellet 12. FIG. 1 is only intended to schematically illustrate that the protein ingredient 20 and the binder 22 are combined within the pellet 12; FIG. 1 merely shows one example of the arrangement of the protein ingredient 20 and the binder 22 in the pellet 12 formed of the soil amendment 10, and many other arrangements are possible according to the embodiments described herein. Similar appearing elements of the soil amendment 10 forming the pellet 12 in FIG. 1, even though they may not be labeled, are likewise the protein ingredient 20 and the binder 22.

The protein ingredient 20 may be an animal-based protein, a plant-based protein, or a combination of an animal-based protein and a plant-based protein. The protein ingredient 20 is approved for use in an organic system according to the definition provided above.

The animal-based protein may be a production by-product or a meat meal. The production by-product is defined as a protein rich element that is formed primarily from a by-product, or waste, produced in an animal production process. The production by-product may, for example, be at least one of feather meal produced from the feather by-product of processing poultry, blood meal produced from the blood by-product of processing ruminants, poultry, or pork, poultry by-product meal produced from other by-products of processing poultry, and any other protein rich element known to those with ordinary skill in the art that is formed primarily from a by-product, or waste, produced in an animal production process. The meat meal is defined as a protein rich element that is primarily formed directly from animal meat. The meat meal may be, for example, at least one of meat and bone meal produced from ruminants, poultry, or pork, chicken meal, fish meal, and any other protein rich element known to those with ordinary skill in the art that is primarily formed directly from animal meat.

The plant-based protein may be any protein rich element produced from plants that is used in feed or other agricultural applications. The plant-based protein may be, for example, at least one of corn germ, soybean meal, kamut, rice, millet, spelt, teff, quinoa, field peas, field pea splits, dry beans, okara, and alfalfa meal, and any other protein rich element produced from plants known to those with ordinary skill in the art that is commonly used in feed or other agricultural applications.

The binder 22 is a fibrous material that is a grain processing by-product. The binder 22 is approved for use in an organic system according to the definition provided above. The grain processing by-product is defined as a fibrous element that is formed primarily from a by-product, or waste, produced in a grain production process. The grain processing by-product may, for example, be at least one of wheat middlings (a by-product of the wheat milling process), corn gluten (a by-product from the wet milling process of corn), soybean hulls (a by-product of the extraction of oil from soybean seeds), and any other fibrous element known to those with ordinary skill in the art that is formed primarily from a by-product, or waste, produced in a grain production process.

An overall composition of the soil amendment for use in an organic system 10 formed as the pellet 12 is shown in the following table:

TABLE 1

| Overall Composition | Ingredient % (by weight) |
|---|---|
| Protem Ingredient | 25-85% |
| Binder | 15-75% |

As shown in Table 1, in the overall composition of the soil amendment 10, the protein ingredient 20, according to any combination of the embodiments of the protein ingredient 20 described above, is 25-85% of the soil amendment 10 by weight and the binder 22, according to any combination of the embodiments of the binder 22 described above, is 15-75% of the soil amendment 10 by weight.

In an embodiment, the protein ingredient 20 and the binder 22 are the only ingredients of the soil amendment 10. In another embodiment, the soil amendment 10 can further include an organic pelleting aid, such as lingosulfonate, in an amount of 0.5-1.0% of the soil amendment 10 by weight. The organic pelleting aid may be used in embodiments in which the protein ingredient 20 includes a higher fat content that would lead to a softer pellet 12.

Further exemplary embodiments of the composition of the soil amendment for use in an organic system 10 will now be described in greater detail including with reference to a number of specific exemplary embodiments shown in FIGS. 2A and 2B. The embodiments described herein and shown in FIGS. 2A and 2B are merely illustrative; embodiments other than those described are possible within the scope of the invention, which is defined by the claims.

In an embodiment, as shown in the following table, the protein ingredient 20 can be formed entirely from the animal-based protein, without any plant-based protein:

TABLE 2

| | |
|---|---|
| Composition 1 | Ingredient % (by weight) |

| | | |
|---|---|---|
| Protein Ingredient | (Animal-Based Protein) | 25-85% |
| Binder | | 15-75% |

Some exemplary embodiments shown in FIGS. 2A and 2B likewise are formed exclusively of at least one animal-based protein described above as the protein ingredient 20 and the binder 22, with no plant-based protein. In some embodiments, for example, the protein ingredient 20 includes at least one of feather meal and poultry by-product meal, incorporating the production by-products as the animal-based protein, as 40-60% of the soil amendment 10 by weight. These embodiments can also include blood meal as 10-35% of the soil amendment 10 by weight. In other embodiments, the protein ingredient 20 includes at least one of chicken meal and fish meal, incorporating the meat meals as the animal-based protein, as 25-75% of the soil amendment 10 by weight, optionally also with blood meal as 10-35% of the soil amendment 10 by weight.

In another embodiment shown in the following table, the protein ingredient 20 of the soil amendment for use in an organic system 10 can include both at least one animal-based protein and at least one plant-based protein:

TABLE 3

| Composition 2 | Ingredient % (by weight) | |
|---|---|---|
| Protein Ingredient | (Animal-Based Protein) | 10-359% |
| | (Plant-Based Protein) | 25-50% |

| | |
|---|---|
| Binder | 15-75% |

In this embodiment, as shown in Table 3, the protein ingredient 20 includes the plant-based protein as 25-50% of the soil amendment 10 by weight and the animal-based protein as 10-35% of the soil amendment 10 by weight. Some specific exemplary embodiments incorporating both at least one plant-based protein described above and at least one animal-based protein described above as the protein ingredient 20 are shown in FIGS. 2A and 2B.

In an embodiment, the binder 22 can be formed entirely of wheat middlings, as shown in the following table:

TABLE 4

| Composition 3 | Ingredient % (by weight) |
|---|---|
| Protein Ingredient | 25-85% |

| | | |
|---|---|---|
| Binder | | |
| | (Wheat Middlings) | 15-75% |

Alternatively, the binder 22 can be formed of a combination of corn gluten and soybean hulls, as shown in the following table:

TABLE 5

| Composition 4 | Ingredient % (by weight) |
|---|---|
| Protein Ingredient | 25-85% |

| | | |
|---|---|---|
| Binder | | |
| | (Corn Gluten) | 15-25% |
| | (Soybean Hulls) | 20-30% |

In this embodiment, as shown in Table 5, the binder 22 includes corn gluten as 15-25% of the soil amendment 10 by weight and soybean hulls as 20-30% of the soil amendment 10 by weight. Some specific exemplary embodiments incorporating the wheat middlings as the binder 22 or the combination of the corn gluten and the soybean hulls as the binder 22 are shown in FIGS. 2A and 2B.

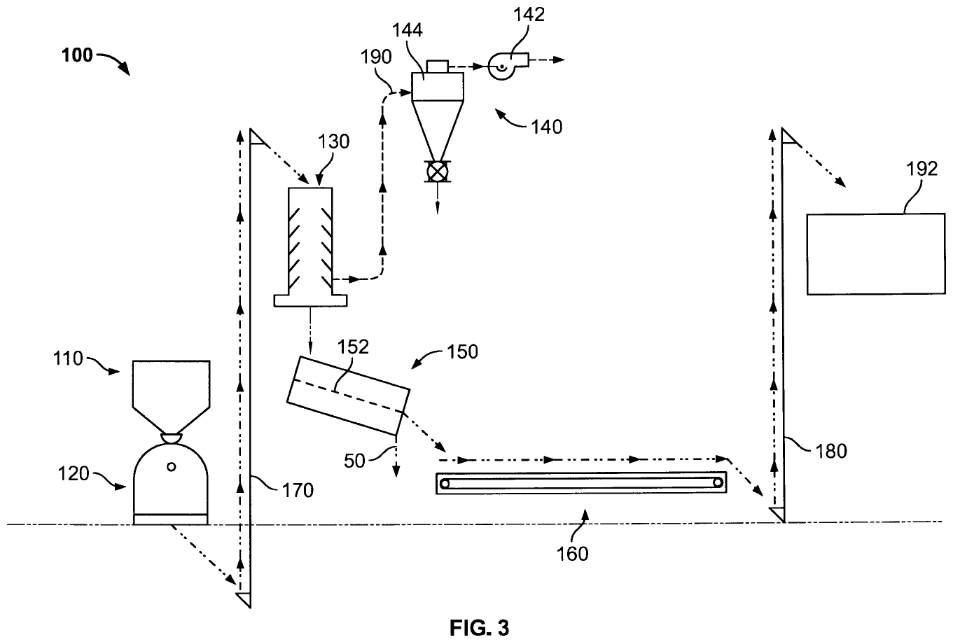

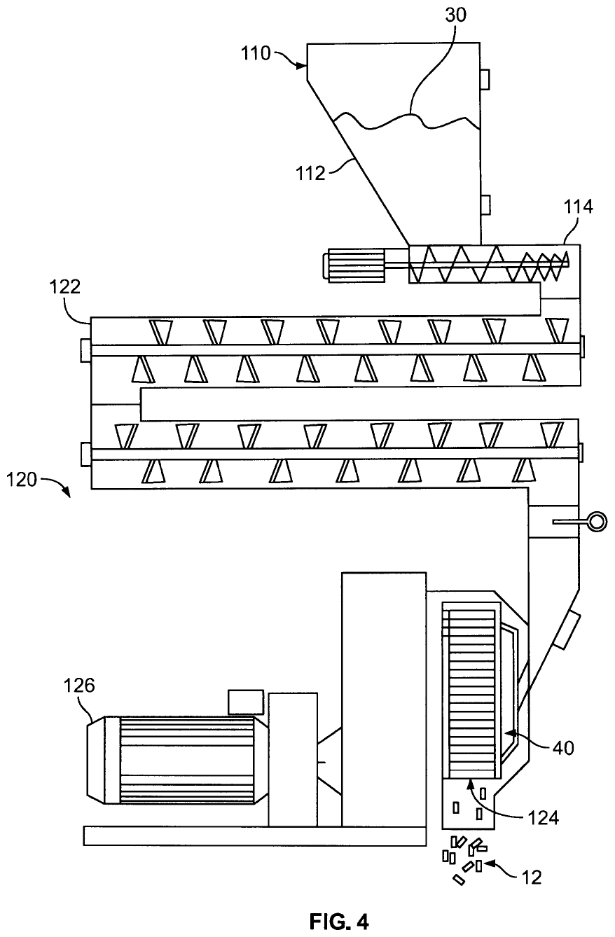

A processing system 100 used to manufacture the soil amendment for use in an organic system 10 as the pellet 12 is shown in FIGS. 3 and 4. The processing system 100 includes a feeder bin 110, a pellet mill 120 connected to the feeder bin 110, a cooler 130, an air device 140 connected to the cooler 130, a shaker 150, and a conveyor 160.

The feeder bin 110 and the pellet mill 120 are shown in greater detail in FIG. 4. In the shown embodiment, the feeder bin 110 is disposed on the pellet mill 120 and includes an open container 112 and a feeding device 114 disposed at a bottom of the open container 112. The feeding device 114 may be any device, such as a feed screw, that is operable to feed or transport a mixed material from the open container 112 to another device.

The pellet mill 120, as shown in FIG. 4, has a conditioner 122 connected to the feeding device 114, and a die 124 that is rotatable by the motor 126. The conditioner 122 heats and/or steams a material contained within the conditioner 122, for example via a boiler, while transporting the material. The die 124 is connected to an output of the conditioner 122. The die 124 includes a die plate, which is a solid element with a plurality of openings that have shapes corresponding to the desired shapes of the pellets 12, and a rotary element disposed within the die plate. The rotary element is rotatable by the motor 126 to press a material contained within the die 124 through the die plate, extruding the material into a different form.

The cooler 130, as shown in FIG. 3, is connected to the air device 140 by an air flow 190. The cooler 130 may be any device, for example a tower-shaped element having a plurality of side vents, that can hold a material while the air flow 190 passes through the cooler 130 and cools the material held in the cooler 130. The air device 140 generates the air flow 190 with a fan 142. In the shown embodiment, the air device 140 has a cyclone 144 that forces solid particles that pass from the cooler 130 to the cyclone 144 to walls of the cyclone 144, partially filtering the air flow 190.

The shaker 150 shown in FIG. 3 includes an angled platform 152 on which a material falls. The material moves along the angled platform 152 and the shaker 150 shakes or vibrates to separate the material on the angled platform 152 into larger and smaller pieces.

The conveyer 160, shown in FIG. 3, may be any type of continuously looped, belted element or other conveying device that can horizontally move a material from one end to another.

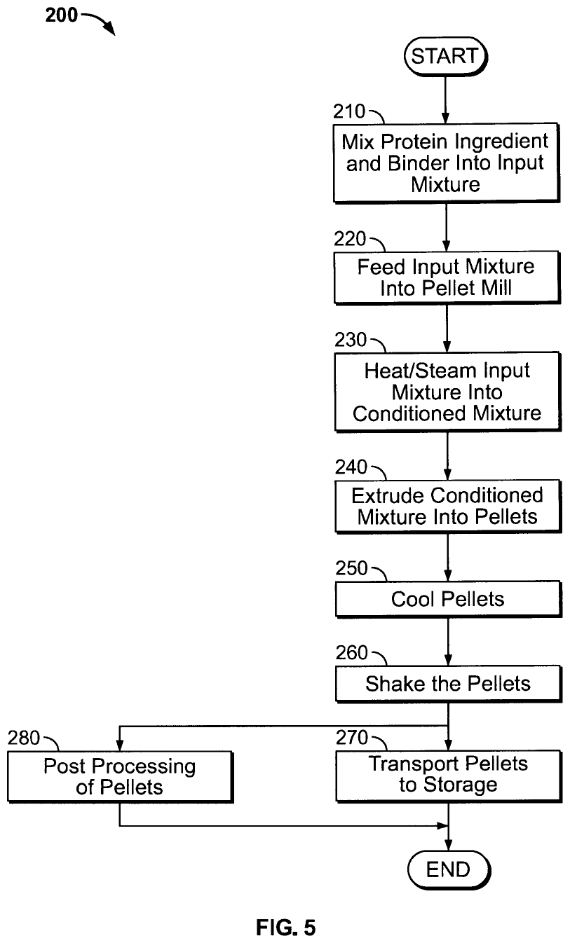

The process 200 used to produce the pellets 12 of the soil amendment for use in an organic system 10 incorporating the processing system 100 is shown in FIG. 5. The process 200 will now be described in detail with respect to FIG. 5, also referring to the elements of the processing system 100 shown in FIGS. 3 and 4.

In a first step 210 of the process 200, the protein ingredient 20 and the binder 22 are mixed into an input mixture 30. The mixing can be performed manually or by any type of device capable of combining the protein ingredient 20 and the binder 22 into the input mixture 30.

In a second step 220 of the process 200 shown in FIG. 5, the input mixture 30 is fed into the feeder bin 110 and the pellet mill 120. As shown in FIG. 4, the input mixture 30 is positioned in the feeder bin 110 and the feeding device 114 feeds the input mixture 30 from the feeder bin 110 to the conditioner 122 of the pellet mill 120.

In a third step 230, the conditioner 122 heats and/or steams the input mixture 30 to turn the input mixture 30 into a conditioned mixture 40, shown in FIG. 4. The heating and/or steaming of the input mixture 30 to condition the input mixture 30 into the conditioned mixture 40 increases an adhesion of the protein ingredient 20 and the binder 22, which improves the overall quality of the resulting pellet 12.

The conditioner 122 feeds the conditioned mixture 40 to the die 124. In a step 240 of the process 200 in FIG. 5, the conditioned mixture 40 is forced by the rotation of the rotary element of the die 124 through the openings of the solid element of the die 124, extruding the conditioned mixture 40 into a plurality of pellets 12 shown in FIG. 4. The high temperature and high pressure in the die 124 causes physical and chemical changes to the conditioned mixture 40, which further increases the adhesion of the protein ingredient 20 and the binder 22 into the pellet 12 form. The pellets 12 output from the pellet mill 120, in the shown embodiment, are solid, cylindrical elements of the soil amendment 10.

A first transporter 170 of the processing system 100, shown in FIG. 3, then transports the pellets 12 to the cooler 30. The first transporter 170 may be any type of vertical lifting conveyer used in grain applications. In the cooler 130, in a step 250 shown in FIG. 5, the pellets 12 are cooled by the air flow 190 from the air device 140 and are passed on to the shaker 150.

In a step 260 shown in FIG. 5, the shaker 150 shakes the pellets 12 while transporting the pellets 12, separating a plurality of fine materials 50 left over from production of the pellets 12. The shaker 150 transports the pellets 12 to the conveyor 160.

In a step 270, the conveyor 160 and a second transporter 180 transport the pellets 12 to a storage element, such as a storage bin 192 shown in FIG. 3. The second transporter 180 may be any type of vertical lifting conveyer used in grain applications. The pellets 12 in the storage bin 192 can then be transported to any site for application of the soil amendment 10 in pellet 12 form. In another embodiment, in a step 280 shown in FIG. 5, the pellets 12 can be post processed prior to the transportation in step 270 to create smaller pieces of the pellets 12, depending on the application.

The composition of the soil amendment for use in an organic system 10 according to the invention aids in the growing of crops and other plants while maintaining the organic status of the plants. The soil amendment 10 can be used as a starter fertilizer in the early stages of plant growth, as a side dress fertilizer during growth, and in late-season pre-harvest applications. The binder 22 creates an optimal, solid pellet 12 form with the protein ingredient 20 while, in the embodiments of the binder 22 material described above, also providing fertilizing nutrients. The formation of the soil amendment 10 as the pellets 12 allows for easier storage, transportation and application, such as via a planter or a spreader, of the soil amendment 10 at any desired time during the growth cycle in a variety of both commercial and residential applications.

What is claimed is:

1. A soil amendment for use in an organic system, comprising:
a protein ingredient that is at least one of a plant-based protein and an animal-based protein; and
a binder binding with the protein ingredient to form a pellet, the binder is a grain processing by-product.

2. The soil amendment for use in an organic system of claim 1, wherein the binder is a fibrous material.

3. The soil amendment for use in an organic system of claim 2, wherein the binder is at least one of wheat middlings, corn gluten, and soybean hulls.

4. The soil amendment for use in an organic system of claim 1, wherein the animal-based protein is a production by-product or a meat meal.

5. The soil amendment for use in an organic system of claim 4, wherein the protein ingredient is the production by-product and is at least one of feather meal, blood meal, and poultry by-product meal.

6. The soil amendment for use in an organic system of claim 4, wherein the protein ingredient is the meat meal and is at least one of meat and bone meal of one of a plurality of different types of animals, chicken meal, and fish meal.

7. The soil amendment for use in an organic system of claim 1, wherein the plant-based protein is at least one of corn germ, soybean meal, kamut, rice, millet, spelt, teff, quinoa, field peas, field pea splits, dry beans, okara, and alfalfa meal.

8. The soil amendment for use in an organic system of claim 1, wherein the protein ingredient is 25-85% of the soil amendment by weight and the binder is 15-75% of the soil amendment by weight.

9. The soil amendment for use in an organic system of claim 8, wherein the protein ingredient is formed entirely of the animal-based protein.

10. The soil amendment for use in an organic system of claim 9, wherein the protein ingredient includes at least one of feather meal and poultry by-product meal as 40-60% of the soil amendment by weight.

11. The soil amendment for use in an organic system of claim 10, wherein the protein ingredient includes blood meal as 10-35% of the soil amendment by weight.

12. The soil amendment for use in an organic system of claim 9, wherein the protein ingredient includes at least one of chicken meal and fish meal as 25-75% of the soil amendment by weight.

13. The soil amendment for use in an organic system of claim 8, wherein the protein ingredient includes the plant-based protein as 25-50% of the soil amendment by weight and the animal-based protein as 10-35% of the soil amendment by weight.

14. The soil amendment for use in an organic system of claim 8, wherein the binder is formed entirely of wheat middlings.

15. The soil amendment for use in an organic system of claim 8, wherein the binder includes corn gluten as 15-25% of the soil amendment by weight and soybean hulls as 20-30% of the soil amendment by weight.

16. A process of manufacturing a soil amendment for use in an organic system, comprising:
mixing a protein ingredient and a binder into an input mixture, the protein ingredient is at least one of a plant-based protein and an animal-based protein, the binder is a grain processing by-product;
feeding the input mixture into a pellet mill; and
processing the input mixture with the pellet mill to output a pellet of the soil amendment that is formed of the protein ingredient and the binder, the binder binds with the protein ingredient to form the pellet.

17. The process of claim 16, further comprising cooling the pellet with an air flow from an air device.

18. The process of claim 16, further comprising shaking the pellet to separate the pellet from a plurality of fine materials left over from the processing with the pellet mill.

19. The process of claim 16, wherein the pellet mill has a conditioner in which the input mixture is heated and/or steamed and formed into a conditioned mixture.

20. The process of claim 19, wherein a die of the pellet mill extrudes the conditioned mixture into the pellet.
